(19) United States
(12) Patent Application Publication
(10) Pub. No.: US 2020/0380928 A1
(43) Pub. Date: Dec. 3, 2020

(54) PIXEL DRIVING CIRCUIT AND PIXEL DRIVING METHOD

(71) Applicant: TCL CHINA STAR OPTOELECTRONICS TECHNOLOGY CO., LTD., Shenzhen (CN)

(72) Inventors: Bobiao CHANG, Shenzhen, Guangdong (CN); Yichien Wen, Shenzhen, Guangdong (CN)

(21) Appl. No.: 16/616,500

(22) PCT Filed: Jun. 25, 2019
(86) PCT No.: PCT/CN2019/092710

§ 371 Date: Nov. 25, 2019

(30) Foreign Application Priority Data
May 29, 2019 (CN) 201910459438.9

(51) Int. Cl. G09G 3/36

(52) U.S. Cl. CPC G09G 3/3614; G09G 3/3659; G09G 2300/0426; G09G 3/3674; G09G 3/3696

(57) ABSTRACT

A pixel driving circuit and a pixel driving circuit method are provided. The pixel driving circuit includes sub-pixels arranged in an array, scanning lines extended in a horizontal direction, and data lines extended in a vertical direction. Each of the scanning lines is connected to a row of the sub-pixels, and a column of the sub-pixels is alternately connected to the data lines adjacent to the column of the sub-pixels. Odd-numbered scanning lines are configured to transmit a scanning signal to an odd-numbered row of the sub-pixels in an odd-numbered frame of display, and even-numbered scanning lines are configured to transmit a scanning signal to an even-numbered row of the sub-pixels in an even-numbered frame of display, and the data lines are configured to transmit a voltage signal to the sub-pixels, and a polarity of the signal is changed every two frames of display.

### FIELD OF INVENTION

The present disclosure relates to a display technology field, and in particular, relates to a pixel driving circuit and a pixel driving circuit method.

### BACKGROUND OF INVENTION

Thin film transistors (TFTs) are the main driving components of liquid crystal displays (LCDs) and active matrix organic light-emitting diodes (AMOLEDs). They are directly related to display performance of a flat panel display device.

Most of the liquid crystal displays from the present market are backlight type liquid crystal displays, which include a liquid crystal display panel and a backlight module. Working principle of the liquid crystal display panel is to fill liquid crystal molecules between a thin film transistor array substrate (TFT array substrate) and a color filter (CF) substrate, and a pixel voltage and a common voltage are applied on the two substrates, respectively. The rotation direction of the liquid crystal molecules is controlled by an electric field formed between the pixel voltage and the common voltage to transmit the light of the backlight module to display.

Liquid crystal molecule has a characteristic. If the same direction voltage is applied to the liquid crystal molecules for a long time, the liquid crystal molecules are polarized. Even if the voltage is removed, the liquid crystal molecules can no longer be rotated by the change of the electric field because of the disappearance of the characteristic. Therefore, the liquid crystal display panel must be driven by an alternating voltage. When displaying, the liquid crystal molecules are flipped at a certain frequency to prevent the liquid crystal molecules from being biased in the same direction and losing activity. At present, the liquid crystal display panel supports a plurality of flip modes, such as a dot flip mode, a row flip mode, a column flip mode, and the like. The way to achieve the flipping is mainly to continuously alternate the positive and negative polarities of the TFT source voltage (the positive and negative polarities of the signal voltage), or to alternate the positive and negative polarities of the common electrode to achieve the purpose of AC voltage driving.

Referring to FIG. 1, a schematic view of a conventional pixel driving circuit is illustrated. The conventional pixel driving circuit includes a plurality of sub-pixels 10′ arranged in an array, a plurality of scanning lines 20′ extended in a horizontal direction, and a plurality of data lines 30′ extended in a vertical direction. Each of the scanning lines 20′ are connected to a row of the sub-pixels 10′. Each of the column of the sub-pixels 10′ are interleaved to the data lines 30′ adjacent the column of sub-pixels 10′. The odd-numbered scanning lines 20′ and the even-numbered scanning lines 20′ alternately transmit scanning signals to the odd-numbered row of sub-pixels 10′ and the even-numbered row of sub-pixels 10′. In other words, the odd-numbered row of the sub-pixels 10′ are turned on when the odd-numbered frame of the display is displayed, and the even-numbered row of the sub-pixels 10′ are turned on when the even-numbered frame of the display is displayed. A polarity of the signal of the data line 30′ is changed every frames of display. For example, the sub-pixels 10′ are located in the odd-numbered rows of the first column of sub-pixels 10′ are turned on when the first frame of the display is displayed. The data lines 30′ transmit a positive voltage to the sub-pixels 10′ are located in the odd-numbered rows of the first column of sub-pixels 10. The sub-pixels 10′ are located in the odd-numbered rows of the first column of sub-pixels 10′ are turned off when the second frame of the display is displayed. The sub-pixels 10′ are located in the even-numbered rows of the first column of sub-pixels 10′ are turned on when the second frame of the display is displayed. The data lines 30′ transmit a negative voltage to the sub-pixels 10′ are located in the even-numbered rows of the first column of sub-pixels 10. The sub-pixels 10′ are located in the odd-numbered rows of the first column of sub-pixels 10′ are turned on when the third frame of the display is displayed. The data lines 30′ transmit a positive voltage to the sub-pixels 10′ are located in the odd-numbered rows of the first column of sub-pixels 10, and so on. However, the conventional pixel driving method causes the polarity of the voltage of the sub-pixels 10′ to be unchanged, thereby causing polarization of the liquid crystal. Therefore, the uniformity of the display is deteriorated, and the quality of the display is affected.

### SUMMARY OF INVENTION

An object of the present disclosure is to provide a pixel driving circuit, which can solve the problem that the liquid crystal is polarized, improve the uniformity of the display to some extent, and increase the quality of the display.

An object of the present disclosure is to provide a pixel driving method, which also can solve the problem that the liquid crystal is polarized, improve the uniformity of the display to some extent, and increase the quality of the display.

To achieve the above objects, the present disclosure provides a pixel driving circuit, and the pixel driving circuit includes a plurality of sub-pixels arranged in an array, a plurality of scanning lines extended in a horizontal direction, and a plurality of data lines extended in a vertical direction, wherein each of the scanning lines is connected to a row of the sub-pixels, and a column of the sub-pixels is alternately connected to the data lines adjacent to the column of the sub-pixels, odd-numbered scanning lines are configured to transmit a scanning signal to an odd-numbered row of the sub-pixels in an odd-numbered frame of display, even-numbered scanning lines are configured to transmit a scanning signal to an even-numbered row of the sub-pixels in an even-numbered frame of display, and the data lines are configured to transmit a voltage signal to the sub-pixels, and a polarity of the signal is changed every two frames of display.

In one embodiment of the present disclosure, a sub-pixel located in an odd-numbered row in a column of the sub-pixels is connected to a data line adjacent to a right side of the column of the sub-pixels, and a sub-pixel located in an even-numbered row in a column of the sub-pixels is connected to a data line adjacent to a left side of the column of the sub-pixels.

In one embodiment of the present disclosure, the data lines alternately transmit the voltage signals with different polarities in the same frame of display.

In one embodiment of the present disclosure, the pixel driving circuit further includes a first gate driver on array (GOA) unit connected to the odd-numbered scanning lines and a second GOA unit connected to the even-numbered scanning lines; the first GOA unit and the second GOA unit are configured to transmit scanning signals to the odd-numbered scanning lines and the even-numbered scanning lines, respectively.

In one embodiment of the present disclosure, the pixel driving circuit further includes a source driver connected to the data lines, and the source driver is configured to transmit a voltage signal to the data lines.

To achieve the above objects, the present disclosure provides a pixel driving method, and the pixel driving method includes steps of step S1, providing a pixel driving circuit, wherein the pixel driving circuit includes a plurality of sub-pixels arranged in an array, a plurality of scanning lines extended in a horizontal direction, and a plurality of data lines extended in a vertical direction, wherein each of the scanning lines is connected to a row of the sub-pixels, and a column of the sub-pixels is alternately connected to the data lines adjacent to the column of the sub-pixels; step S2, odd-numbered scanning lines transmitting a scanning signal to an odd-numbered row of the sub-pixels in an odd-numbered frame of display and even-numbered scanning lines transmitting a scanning signal to an even-numbered row of the sub-pixels in an even-numbered frame of display; and step S3, the data lines transmitting a voltage signal to the sub-pixels, and a polarity of the signal is changed every two frames of display.

In one embodiment of the present disclosure, a sub-pixel located in an odd-numbered row in a column of the sub-pixels is connected to a data line adjacent to a right side of the column of the sub-pixels, and a sub-pixel located in an even-numbered row in a column of the sub-pixels is connected to a data line adjacent to a left side of the column of the sub-pixels.

In one embodiment of the present disclosure, in the step S3, the data lines alternately transmit the voltage signals with different polarities in the same frame of display.

In one embodiment of the present disclosure, the pixel driving circuit further includes a first gate driver on array (GOA) unit connected to the odd-numbered scanning lines and a second GOA unit connected to the even-numbered scanning lines; in the step S2, the first GOA unit and the second GOA unit are configured to transmit scanning signals to the odd-numbered scanning lines and the even-numbered scanning lines, respectively.

In one embodiment of the present disclosure, the pixel driving circuit further includes a source driver connected to the data lines; in the step S2, the source driver transmits a voltage signal to the data lines.

In the advantageous effects of the present disclosure, the pixel driving circuit of the present disclosure includes a plurality of sub-pixels arranged in an array, a plurality of scanning lines extended in a horizontal direction, and a plurality of data lines extended in a vertical direction, wherein each of the scanning lines is connected to a row of the sub-pixels, and a column of the sub-pixels is alternately connected to the data lines adjacent to the column of the sub-pixels. Odd-numbered scanning lines are configured to transmit a scanning signal to an odd-numbered row of the sub-pixels in an odd-numbered frame of display, and even-numbered scanning lines are configured to transmit a scanning signal to an even-numbered row of the sub-pixels in an even-numbered frame of display, and the data lines are configured to transmit a voltage signal to the sub-pixels, and a polarity of the signal is changed every two frames of display. It can solve the problem that the liquid crystal is polarized, improve the uniformity of the display to some extent, and increase the quality of the display. The pixel driving method of the of the present disclosure also can solve the problem that the liquid crystal is polarized, improve the uniformity of the display to some extent, and increase the quality of the display.

### DESCRIPTION OF DRAWINGS

In order to more clearly illustrate the embodiments or prior art technical solutions embodiment of the present disclosure, will implement the following figures for the cases described in prior art or require the use of a simple introduction. Obviously, the following description of the drawings are only some of those of ordinary skill in terms of creative effort without precondition, you can also obtain other drawings based on these drawings embodiments of the present disclosure.

FIG. 1 is a schematic view of a conventional pixel driving circuit.

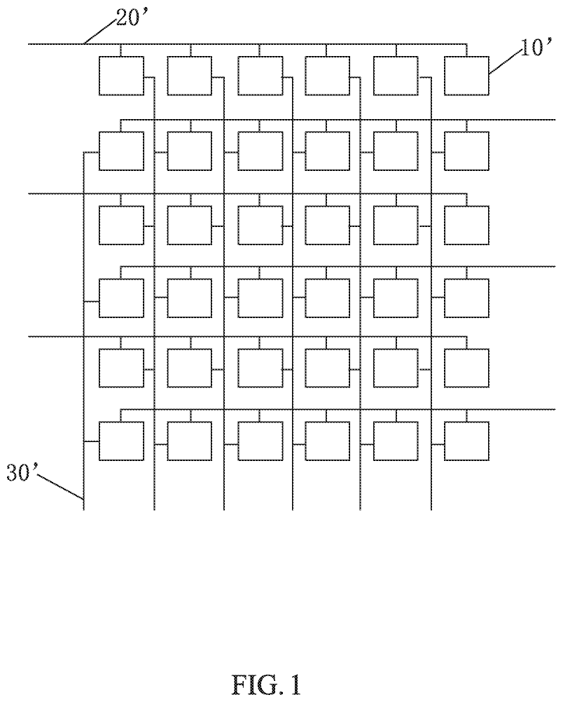

FIG. 2 is a schematic view of a pixel driving circuit according to the present disclosure.

FIG. 3 is a flowchart of a pixel driving method according to the present disclosure.

### DETAILED DESCRIPTION OF PREFERRED EMBODIMENTS

Structure and technical means adopted by the present disclosure to achieve the above and other objects can be best understood by referring to the following detailed description of the preferred embodiments and the accompanying drawings. Furthermore, directional terms described by the present disclosure, such as upper, lower, front, back, left, right, inner, outer, side, longitudinal/vertical, transverse/horizontal, etc., are only directions by referring to the accompanying drawings, and thus the used directional terms are used to describe and understand the present disclosure, but the present disclosure is not limited thereto.

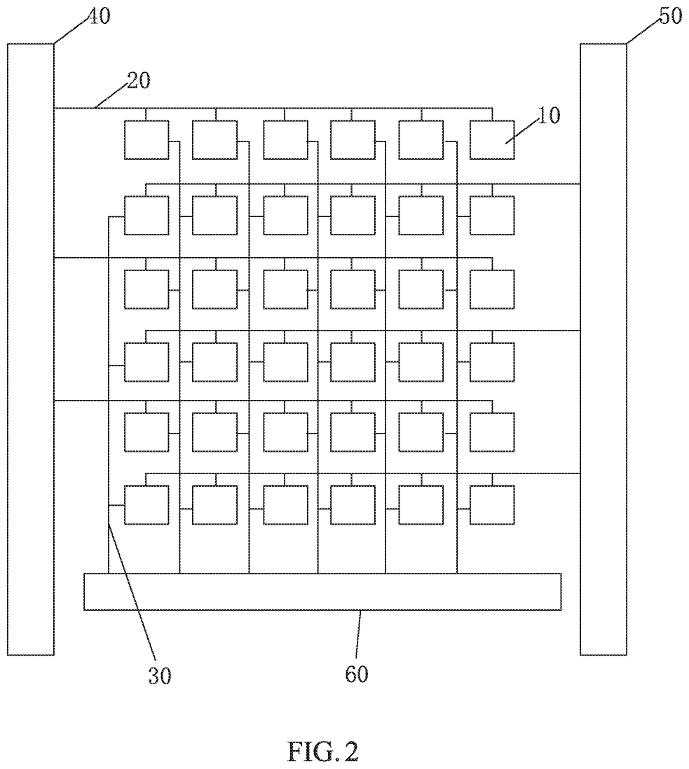

Referring to FIG. 2, a schematic view of a pixel driving circuit according to the present disclosure is illustrated. The pixel driving circuit includes a plurality of sub-pixels 10 arranged in an array, a plurality of scanning lines 20 extended in a horizontal direction, and a plurality of data lines 30 extended in a vertical direction, wherein each of the scanning lines 20 is connected to a row of the sub-pixels 10, and a column of the sub-pixels 10 is alternately connected to the data lines 30 adjacent to the column of the sub-pixels 10.

Odd-numbered scanning lines 20 are configured to transmit a scanning signal to an odd-numbered row of the sub-pixels 10 in an odd-numbered frame of display, even-numbered scanning lines 20 are configured to transmit a scanning signal to an even-numbered row of the sub-pixels 10 in an even-numbered frame of display, and the data lines 30 are configured to transmit a voltage signal to the sub-pixels 10, and a polarity of the signal is changed every two frames of display.

It should be noted, the present disclosure is provided by the following, the odd-numbered scanning lines 20 are configured to transmit a scanning signal to the odd-numbered row of the sub-pixels 10 in the odd-numbered frame of display, and the even-numbered scanning lines 20 are configured to transmit a scanning signal to the even-numbered row of the sub-pixels 10 in the even-numbered frame of display. In other words, the odd-numbered row of the sub-pixels 10 are turned on in an odd-numbered frame of display, and the even-numbered row of the sub-pixels 10 are turned on in the even-numbered frame of display. The data lines 30 are configured to transmit a voltage signal to the sub-pixels, and a polarity of the signal is changed every two frames of display. It can solve the problem that the liquid crystal is polarized, improve the uniformity of the display to some extent, and increase quality of the display.

The first column of sub-pixels 10 is taken as an example, all data lines 30 transmit the same polarity voltage signal in the same frame of display. The sub-pixels 10 located in the odd-numbered rows of the first column of sub-pixels 10 are turned on when the first frame of the display is displayed, and the sub-pixels 10 located in the even-numbered rows of the first column of sub-pixels 10 are turned off when the first frame of the display is displayed. The data lines 30 transmit a positive voltage signal to the sub-pixel 10 located in the odd-numbered rows of the first column of sub-pixels 10.

The sub-pixels 10 located in the odd-numbered rows of the first column of sub-pixels 10 are turned off when the second frame of the display is displayed, and the sub-pixels 10 located in the even-numbered rows of the first column of sub-pixels 10 are turned on when the second frame of the display is displayed. The data lines 30 transmit a positive voltage signal to the sub-pixel 10 located in the even-numbered rows of the first column of sub-pixels 10.

The sub-pixels 10 located in the odd-numbered rows of the first column of sub-pixels 10 are turned on when the third frame of the display is displayed, and the sub-pixels 10 located in the even-numbered rows of the first column of sub-pixels 10 are turned off when the third frame of the display is displayed. The data lines 30 transmit a negative voltage signal to the sub-pixel 10 located in the odd-numbered rows of the first column of sub-pixels 10.

The sub-pixels 10 located in the odd-numbered rows of the first column of sub-pixels 10 are turned off when the fourth frame of the display is displayed, and the sub-pixels 10 located in the even-numbered rows of the first column of sub-pixels 10 are turned on when the fourth frame of the display is displayed. The data lines 30 transmit a negative voltage signal to the sub-pixel 10 located in the evens-numbered rows of the first column of sub-pixels 10.

And so on, a polarity of the signal is changed every two frames of display in each of the sub-pixels 10, thereby solving the problem that the liquid crystal is polarized.

Specifically, gate driver on array (GOA), which uses an array process of a conventional thin film transistor liquid crystal panel to integrate a gate line scan driving circuit on an array substrate, the pixel driving circuit further includes a first GOA unit 40 connected to the odd-numbered scanning lines 20 and a second GOA unit 50 connected to the even-numbered scanning lines 20.

The first GOA unit 40 and the second GOA unit 50 are configured for transmitting scanning signals to the odd-numbered scanning lines 20 and the even-numbered scanning lines 20, respectively.

Furthermore, the first GOA unit 40 and the second GOA unit 50 are respectively located at the two sides of the sub-pixels 10.

Specifically, the pixel driving circuit further includes a source driver 60 connected to the data lines 30, wherein the source driver 60 is configured to transmit the voltage signal to the data line 30.

Specifically, the data lines 30 alternately transmit voltage signals of different polarities in the same frame of display. For example, in the first frame of display, the first data line 30 transmits a negative voltage signal, the second data line 30 transmits a positive voltage signal, the third data line 30 transmits a negative voltage signal, and so on.

Specifically, the sub-pixels 10 are located in the odd-numbered rows in the column of sub-pixels 10 are connected to the data lines 30 adjacent to the right side of the column of sub-pixels 10. The sub-pixels 10 are located in the even-numbered rows of in the column of sub-pixels 10 are connected to the data lines 30 adjacent to the left side of the column of sub-pixels 10.

The first column of sub-pixels 10 is taken as an example, and all data lines 30 alternately transmit voltage signals of different polarities in the same frame of display. The sub-pixels 10 are located in the odd-numbered rows in the first column of sub-pixels 10 are turned on when the first frame of the display is displayed. The sub-pixels 10 are located in the even-numbered rows in the first column of sub-pixels 10 are turned off when the first frame of the display is displayed. The data lines 30 adjacent to the right side of the first column of the sub-pixels 10 transmit a positive voltage signal to the sub-pixels 10 located in odd-numbered rows in the first column of sub-pixels 10.

The sub-pixels 10 are located in the odd-numbered rows in the first column of sub-pixels 10 are turned off when the second frame of the display is displayed. The sub-pixels 10 are located in the even-numbered rows in the first column of sub-pixels 10 are turned on when the second frame of the display is displayed. The data lines 30 adjacent to the left side of the first column of the sub-pixels 10 transmit a negative voltage signal to the sub-pixels 10 located in even-numbered rows in the first column of sub-pixels 10.

The sub-pixels 10 are located in the odd-numbered rows in the first column of sub-pixels 10 are turned on when the third frame of the display is displayed. The sub-pixels 10 are located in the even-numbered rows in the first column of sub-pixels 10 are turned off when the third frame of the display is displayed. The data lines 30 adjacent to the right side of the first column of the sub-pixels 10 transmit a negative voltage signal to the sub-pixels 10 located in odd-numbered rows in the first column of sub-pixels 10.

The sub-pixels 10 are located in the odd-numbered rows in the first column of sub-pixels 10 are turned off when the fourth frame of the display is displayed. The sub-pixels 10 are located in the even-numbered rows in the first column of sub-pixels 10 are turned on when the fourth frame of the display is displayed. The data lines 30 adjacent to the left side of the first column of the sub-pixels 10 transmit a positive voltage signal to the sub-pixels 10 located in even-numbered rows in the first column of sub-pixels 10.

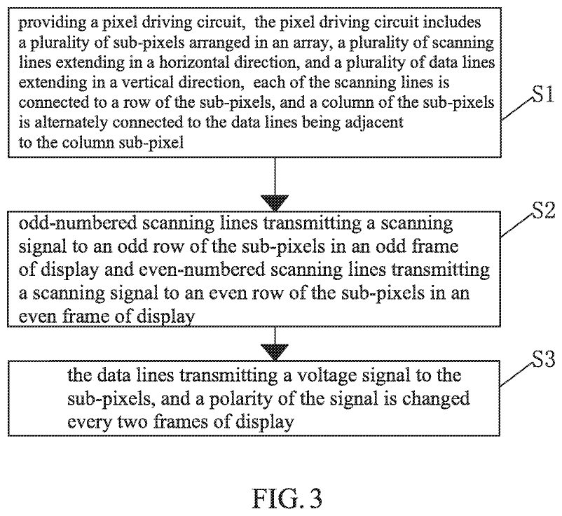

Referring to FIG. 3, a flowchart of a pixel driving method according to the present disclosure is illustrated. The pixel driving method includes steps of:

Step S1, providing a pixel driving circuit, wherein the pixel driving circuit includes a plurality of sub-pixels 10 arranged in an array, a plurality of scanning lines 20 extended in a horizontal direction, and a plurality of data lines 30 extended in a vertical direction, wherein each of the scanning lines 20 is connected to a row of the sub-pixels 10, and a column of the sub-pixels 10 is alternately connected to the data lines 30 adjacent to the column of the sub-pixels.

Step S2, odd-numbered scanning lines 20 transmit a scanning signal to an odd-numbered row of the sub-pixels 10 in an odd-numbered frame of display and even-numbered scanning lines 20 transmit a scanning signal to an even-numbered row of the sub-pixels 10 in an even-numbered frame of display.

Step S3, the data lines 30 transmit a voltage signal to the sub-pixels 10, and a polarity of the signal is changed every two frames of display.

It should be noted, the present disclosure is provided by the following, the odd-numbered scanning lines 20 are configured to transmit a scanning signal to the odd-numbered row of the sub-pixels 10 in the odd-numbered frame of display, and the even-numbered scanning lines 20 are configured to transmit a scanning signal to the even-numbered row of the sub-pixels 10 in the even-numbered frame of display. In other words, the odd-numbered row of the sub-pixels 10 are turned on in an odd-numbered frame of display, and the even-numbered row of the sub-pixels 10 are turned on in the even-numbered frame of display. The data lines 30 are configured to transmit a voltage signal to the sub-pixels, and a polarity of the signal is changed every two frames of display. It can solve the problem that the liquid crystal is polarized, improve the uniformity of the display to some extent, and increase the quality of the display.

The first column of sub-pixels 10 is taken as an example, all data lines 30 transmit the same polarity voltage signal in the same frame of display. The sub-pixels 10 located in the odd-numbered rows of the first column of sub-pixels 10 are turned on when the first frame of the display is displayed, and the sub-pixels 10 located in the even-numbered rows of the first column of sub-pixels 10 are turned off when the first frame of the display is displayed. The data lines 30 transmit a positive voltage signal to the sub-pixel 10 located in the odd-numbered rows of the first column of sub-pixels 10.

The sub-pixels 10 located in the odd-numbered rows of the first column of sub-pixels 10 are turned off when the second frame of the display is displayed, and the sub-pixels 10 located in the even-numbered rows of the first column of sub-pixels 10 are turned on when the second frame of the display is displayed. The data lines 30 transmit a positive voltage signal to the sub-pixel 10 located in the even-numbered rows of the first column of sub-pixels 10.

The sub-pixels 10 located in the odd-numbered rows of the first column of sub-pixels 10 are turned on when the third frame of the display is displayed, and the sub-pixels 10 located in the even-numbered rows of the first column of sub-pixels 10 are turned off when the third frame of the display is displayed. The data lines 30 transmit a negative voltage signal to the sub-pixel 10 located in the odd-numbered rows of the first column of sub-pixels 10.

The sub-pixels 10 located in the odd-numbered rows of the first column of sub-pixels 10 are turned off when the fourth frame of the display is displayed, and the sub-pixels 10 located in the even-numbered rows of the first column of sub-pixels 10 are turned on when the fourth frame of the display is displayed. The data lines 30 transmit a negative voltage signal to the sub-pixel 10 located in the evens-numbered rows of the first column of sub-pixels 10.

And so on, a polarity of the signal is changed every two frames of display in each of the sub-pixels 10, thereby solving the problem that the liquid crystal is polarized.

Specifically, the pixel driving circuit further includes a first gate driver on array (GOA) unit 40 connected to the odd-numbered scanning lines 20 and a second GOA unit 50 connected to the even-numbered scanning lines 20.

In the step S2, the first GOA unit 40 and the second GOA unit 50 are configured for transmitting scanning signals to the odd-numbered scanning lines 20 and the even-numbered scanning lines 20, respectively.

Furthermore, the first GOA unit 40 and the second GOA unit 50 are respectively located at the two sides of the sub-pixels 10.

Specifically, the pixel driving circuit further includes a source driver 60 connected to the data lines 30. In the step S3, the source driver 60 is configured to transmit the voltage signal to the data line 30.

Specifically, in the step S3, the data lines 30 alternately transmit voltage signals of different polarities in the same frame of display. For example, in the first frame of display, the first data line 30 transmits a negative voltage signal, the second data line 30 transmits a positive voltage signal, the third data line 30 transmits a negative voltage signal, and so on.

Specifically, the sub-pixels 10 are located in the odd-numbered rows in the column of sub-pixels 10 are connected to the data lines 30 adjacent to the right side of the column of sub-pixels 10. The sub-pixels 10 are located in the even-numbered rows of in the column of sub-pixels 10 are connected to the data lines 30 adjacent to the left side of the column of sub-pixels 10.

The first column of sub-pixels 10 is taken as an example, and all data lines 30 alternately transmit voltage signals of different polarities in the same frame of display. The sub-pixels 10 are located in the odd-numbered rows in the first column of sub-pixels 10 are turned on when the first frame of the display is displayed. The sub-pixels 10 are located in the even-numbered rows in the first column of sub-pixels 10 are turned off when the first frame of the display is displayed. The data lines 30 adjacent to the right side of the first column of the sub-pixels 10 transmit a positive voltage signal to the sub-pixels 10 located in odd-numbered rows in the first column of sub-pixels 10.

The sub-pixels 10 are located in the odd-numbered rows in the first column of sub-pixels 10 are turned off when the second frame of the display is displayed. The sub-pixels 10 are located in the even-numbered rows in the first column of sub-pixels 10 are turned on when the second frame of the display is displayed. The data lines 30 adjacent to the left side of the first column of the sub-pixels 10 transmit a negative voltage signal to the sub-pixels 10 located in even-numbered rows in the first column of sub-pixels 10.

The sub-pixels 10 are located in the odd-numbered rows in the first column of sub-pixels 10 are turned on when the third frame of the display is displayed. The sub-pixels 10 are located in the even-numbered rows in the first column of sub-pixels 10 are turned off when the third frame of the display is displayed. The data lines 30 adjacent to the right side of the first column of the sub-pixels 10 transmit a negative voltage signal to the sub-pixels 10 located in odd-numbered rows in the first column of sub-pixels 10.

The sub-pixels 10 are located in the odd-numbered rows in the first column of sub-pixels 10 are turned off when the fourth frame of the display is displayed. The sub-pixels 10 are located in the even-numbered rows in the first column of sub-pixels 10 are turned on when the fourth frame of the display is displayed. The data lines 30 adjacent to the left side of the first column of the sub-pixels 10 transmit a positive voltage signal to the sub-pixels 10 located in even-numbered rows in the first column of sub-pixels 10.

As the described above, the pixel driving circuit of the present disclosure includes a plurality of sub-pixels arranged in an array, a plurality of scanning lines extended in a horizontal direction, and a plurality of data lines extended in a vertical direction, wherein each of the scanning lines is connected to a row of the sub-pixels, and a column of the sub-pixels is alternately connected to the data lines adjacent to the column of the sub-pixels. Odd-numbered scanning lines are configured to transmit a scanning signal to an odd-numbered row of the sub-pixels in an odd-numbered frame of display, and even-numbered scanning lines are configured to transmit a scanning signal to an even-numbered row of the sub-pixels in an even-numbered frame of display, and the data lines are configured to transmit a voltage signal to the sub-pixels, and a polarity of the signal is changed every two frames of display. It can solve the problem that the liquid crystal is polarized, improve the uniformity of the display to some extent, and increase the quality of the display.

The pixel driving method of the of the present disclosure also can solve the problem that the liquid crystal is polarized, improve the uniformity of the display to some extent, and increase the quality of the display.

The present disclosure has been described with preferred embodiments thereof and it is understood that many changes and modifications to the described embodiments can be carried out without departing from the scope and the spirit of the disclosure that is intended to be limited only by the appended claims.

This listing of claims replaces all prior versions, and listings, of claims in the application:

1. A pixel driving circuit, comprising:
a plurality of sub-pixels arranged in an array;
a plurality of scanning lines extended in a horizontal direction; and
a plurality of data lines extended in a vertical direction;
a first gate driver on array (GOA) unit connected to odd-numbered scanning lines;
a second GOA unit connected to even-numbered scanning lines;
wherein each of the scanning lines is connected to a row of the sub-pixels, and a column of the sub-pixels is alternately connected to the data lines adjacent to the column of the sub-pixels;
wherein the odd-numbered scanning lines are configured to transmit a scanning signal to an odd-numbered row of the sub-pixels in an odd-numbered frame of display;
wherein the even-numbered scanning lines are configured to transmit a scanning signal to an even-numbered row of the sub-pixels in an even-numbered frame of display;
wherein the data lines are configured to transmit a voltage signal to the sub-pixels, and a polarity of the signal is changed every two frames of display;
the first GOA unit and the second GOA unit are configured to transmit the scanning signals to the odd-numbered scanning lines and the even-numbered scanning lines, respectively.

2. The pixel driving circuit according to claim 1, wherein a sub-pixel located in an odd-numbered row in a column of the sub-pixels is connected to a data line adjacent to a right side of the column of the sub-pixels, and a sub-pixel located in an even-numbered row in a column of the sub-pixels is connected to a data line adjacent to a left side of the column of the sub-pixels.

3. The pixel driving circuit according to claim 1, wherein the data lines alternately transmit the voltage signals with different polarities in the same frame of display.

4. (canceled)

5. The pixel driving circuit according to claim 1, wherein the pixel driving circuit further includes a source driver connected to the data lines, and the source driver is configured to transmit a voltage signal to the data lines.

6. A pixel driving method, comprising steps of:
step S1, providing a pixel driving circuit, wherein the pixel driving circuit includes a plurality of sub-pixels arranged in an array, a plurality of scanning lines extended in a horizontal direction, and a plurality of data lines extended in a vertical direction, a first gate driver on array (GOA) unit connected to odd-numbered scanning lines, and a second GOA unit connected to even-numbered scanning lines, wherein each of the scanning lines is connected to a row of the sub-pixels, and a column of the sub-pixels is alternately connected to the data lines adjacent to the column of the sub-pixels;
step S2, the odd-numbered scanning lines transmitting a scanning signal to an odd-numbered row of the sub-pixels in an odd-numbered frame of display and the even-numbered scanning lines transmitting a scanning signal to an even-numbered row of the sub-pixels in an even-numbered frame of display, wherein the first GOA unit and the second GOA unit are configured to transmit scanning signals to the odd-numbered scanning lines and the even-numbered scanning lines, respectively; and
step S3, the data lines transmitting a voltage signal to the sub-pixels, and a polarity of the signal is changed every two frames of display.

7. The pixel driving method according to claim 6, wherein a sub-pixel located in an odd-numbered row in a column of the sub-pixels is connected to a data line adjacent to a right side of the column of the sub-pixels, and a sub-pixel located in an even-numbered row in a column of the sub-pixels is connected to a data line adjacent to a left side of the column of the sub-pixels.

8. The pixel driving method according to claim 6, wherein in the step S3, the data lines alternately transmit the voltage signals with different polarities in the same frame of display.

9. (canceled)

10. The pixel driving method according to claim 6, wherein the pixel driving circuit further includes a source driver connected to the data lines;
in the step S2, the source driver transmits a voltage signal to the data lines.
